(19) United States
(12) Patent Application Publication
(10) Pub. No.: US 2010/0183110 A1
(43) Pub. Date: Jul. 22, 2010

(54) PACKAGING FOR THE TRANSPORTATION AND/OR STORAGE OF NUCLEAR MATERIALS WHICH INCLUDES RADIOLOGICAL PROTECTION MADE OF LEAD CAST OVER A METALLIC FRAMEWORK

(76) Inventors: Rene Chiocca, Paris (FR); Jean-Marie Lamour, Paris (FR)

Correspondence Address: Nixon Peabody LLP, P.O. Box 60610, Palo Alto, CA, 94306, US

(21) Appl. No.: 12/532,075

(22) PCT Filed: Mar. 18, 2008
(86) PCT No.: PCT/EP08/53191

§ 371 Date: Mar. 5, 2010

(30) Foreign Application Priority Data
Mar. 21, 2007 (FR) 07 53965

(51) Int. Cl. G21F 5/008; B22D 23/00

(52) U.S. Cl. 376/272; 164/47

(57) ABSTRACT

A packaging for the transportation and/or storage of nuclear materials, which includes a lateral body which extends along a longitudinal direction (X), where this body is equipped with a radiological protection device. The radiological protection device includes at least one radiological protection structure which includes at least one metallic reinforcement framework which extends along the direction (X) and which is hugged by a block made out of lead or of one of its alloys, cast over the framework, the latter being equipped with at least one element for retaining the cast block along the direction (X). Furthermore, the framework is embedded in the cast block over at least part of its length along this direction (X).

### CROSS REFERENCE TO RELATED APPLICATIONS OR PRIORITY CLAIM

This application is a national phase of International Application No. PCT/EP2008/053191, entitled “CONTAINER FOR TRANSPORTING AND/OR STORING NUCLEAR MATERIALS, COMPRISING A RADIOLOGICAL SHIELD MADE OF LEAD CAST ONTO A METAL REINFORCEMENT”, which was filed on Mar. 18, 2008, and which claims priority of French Patent Application No. 07 53965, filed Mar. 21, 2007.

### TECHNICAL FIELD

The present invention relates in a general manner to the field of transportation and/or storage of nuclear materials, such as cool or irradiated nuclear fuel assemblies.

In particular the invention relates to a packaging for the transportation and/or storage of nuclear materials, of the type which includes a radiological protection device made of lead or of one of its alloys, in order to form an effective barrier against gamma radiation.

### STATE OF THE ART

Conventionally, in order to undertake the transportation and/or storage of nuclear fuel assemblies, storage devices are used which are also referred to as storage “baskets” or “racks”. These storage devices, usually cylindrical in shape and with an approximately circular cross-section, have several adjacent housings each suitable for holding a nuclear fuel assembly. The storage device is designed to be housed in the cavity in a package so as to form, together with it, a container for the transportation and/or storage of nuclear fuel assemblies, inside which the nuclear material is completely confined.

The aforementioned cavity is generally defined by a lateral body which extends along a lateral direction of the packaging, where this lateral body includes, for example, two concentric metallic shells which together form an annular space inside which is housed a radiological protection device, in particular in order to form a barrier against gamma radiation emitted by the fuel assemblies housed in the cavity.

Conventionally, the radiological protection device is made using several prefabricated elements made of lead or of one of its alloys, distributed around the cavity in the relevant annular space defined by the two metallic shells.

Although lead and its alloys offer satisfactory characteristics in terms of protection against gamma radiation, in particular because of their density, they also nevertheless exhibit the drawback of offering only mediocre mechanical strength, in particular in comparison with that offered by steels.

Thus, because of its poor mechanical characteristics, each prefabricated element made of lead or one of its alloys is likely to undergo significant plastic deformation during the regulatory tests referred to as free-drops onto a non-deformable target. It should be recalled that drop tests are carried out whilst aligning the longitudinal axis of the packaging and of its cavity either in a manner which is approximately perpendicular to the impact surface (generally referred to, then, as an axial or vertical drop), or in a manner which is approximately parallel to it (generally referred to, then, as a lateral or horizontal drop).

The plastic deformations referred to above are more likely to occur when the radiological protection elements made of lead are brought to temperatures which may reach 200° C., such as is the case under normal transportation conditions. Consequently the regulatory drop tests take these conditions into account, which prove to be highly restrictive.

In the case of vertical drops, the plastic deformations observed take the form of compaction of the prefabricated elements made of lead along the longitudinal direction, with the material tending in fact to fill a clearance gap which is necessary for introducing these prefabricated elements between the two shells of the lateral body.

In this respect, it should be noted that the compaction of the lead causes empty spaces to appear between the two shells of the lateral body, where these longitudinally aligned empty spaces are located at one end of the packaging, opposite the end designed to strike the non-deformable target during the vertical free drop. These empty spaces obviously create longitudinal discontinuities in the radiological protection, which may then no longer be satisfactorily ensured on a local basis. These discontinuities may, then, be the source of gamma radiation leaks which are prejudicial in terms of meeting regulatory criteria.

### OBJECT OF THE INVENTION

The purpose of the invention is therefore to remedy, at least in part, the above mentioned drawbacks associated with embodiments of the prior art.

In order to achieve this, the object of the invention is a packaging for the transportation and/or storage of nuclear materials such as irradiated fuel assemblies, where said packaging includes a lateral body which extends in a longitudinal direction of said packaging, with said lateral body forming a cavity for housing nuclear materials and which is equipped with a radiological protection device.

According to the invention, the radiological protection device includes at least one radiological protection structure which includes at least one metallic reinforcement framework which extends along said longitudinal direction and is hugged by a block made out of lead or of one of its alloys, cast over said metallic reinforcement framework, the latter being equipped with at least one element for retaining the cast block along the longitudinal direction. Furthermore, said metallic reinforcement framework is embedded in the cast block over at least part of its length along said longitudinal direction, preferably over its entire length.

Thus each retention element of the reinforcement framework allows a mechanical connection to be made with the cast block made of lead or of one of its alloys, preventing relative movement of these two entities in relation to each other along the longitudinal direction. This means that the compaction of the lead is prevented/limited in the event of a vertical free drop of the packaging along its longitudinal direction.

Consequently the invention means that the formation of prejudicial longitudinal discontinuities in the radiological protection device can be prevented, and as a result advantageously blocks gamma radiation from leaking through the lateral body of the packaging.

As an indication, once the block, hereafter referred to as the lead block, is cast, the metallic reinforcement framework and the lead block preferably form a one-piece assembly, thanks, in particular, to the presence of each retention component hugged by the lead. In other terms, the lead block and metallic framework may be considered to be embedded in each other. Furthermore, in order to reinforce the solidity of the association between the two entities, it is preferentially arranged that after casting the lead adheres to the entire surface of the metallic framework that it covers, although it could be otherwise and still be within the framework of the invention.

It should be noted that the concept of an “embedded” longitudinal part should here be understood to mean a part that is no longer visible, laterally, from the exterior; that is, it is covered by the cast lead. Thus, according to this characteristic, at least one longitudinal part of said metallic framework is laterally covered over its entire circumference, that is, over an angular field of 360° around the longitudinal direction.

This specific feature first of all means that the mechanical link between the lead block and the metallic reinforcement framework which incorporates the retention elements is strengthened. Furthermore it means that any machining of the radiological protection structure envisaged after casting of the lead may be easily carried out, since its lateral circumference is formed entirely made up of this lead, in contrast, for example, to a radiological protection structure which retains the visible parts of the metallic structure over its circumference, which would make any machining of it more difficult to achieve.

Preferably, said metallic reinforcement framework exhibits a shape in any transverse section whatsoever which is not straight. In general terms, this allows it to exhibit good mechanical compression behaviour along the longitudinal direction along which it extends.

For example, the transverse section may be of the zigzag type, with waves, slotted, V or other forms of designs.

Alternatively or simultaneously, said metallic framework may take the form of a hollow structure which defines an internal lateral wall, which delimits a void which extends along said longitudinal direction, and an external lateral wall, where said internal and external lateral walls are then hugged by the cast black, preferably along their entire length in order to achieve a better anchorage of the framework within this block. In this case the transverse section which defines a void may be open or closed, and still be within the framework of the invention. Here the metallic structure preferably takes the form of a hollow beam, for example with a rectangular, square or parallelogram cross-section, but might alternatively have an approximately circular, oval or U-shaped cross-section.

In all events the metallic framework, which in any cross-section whatsoever exhibits a form which is not straight, preferentially adopts an approximately cylindrical geometry, parallel to the longitudinal direction. In other terms, the preferred geometry may be achieved by a straight line parallel to the longitudinal direction, travelling along the length of a path which corresponds to the non-straight transverse cross-section.

The metallic framework is preferably equipped with multiple elements for retaining the cast block along the longitudinal direction, distributed along this same direction. In this respect, it should be noted that this advantageously results in a multiplication of the number of mechanical links between the lead block and its associated metallic framework, enabling the risk of longitudinal compaction of the block in the event of a vertical drop to be limited even further.

According to one preferred embodiment of the present invention, at least one retention element for the cast block takes the form of a through hole made in the said metallic framework, passed through by said cast block. In this case the aforementioned mechanical link is made by the lead block passing through the hole provided in the reinforcement framework, with the hole being preferably completely filled by the lead. It is preferably arranged so that the axis of the holes is arranged approximately orthogonally in relation to the longitudinal direction, in order to achieve maximum effectiveness of these links.

According to another preferred embodiment of the present invention, possibly capable of being combined with the previous one, at least one retention element of the cast block takes the form of a protrusion provided in the said metallic framework and embedded in said cast block. Here the mechanical link is a result of the embedded nature of the protrusion in the lead block. For maximum effectiveness of this link, the purpose of which is once more to prevent relative movement of the two entities in relation to one another along the longitudinal direction, it is preferably arranged so that said protrusion is aligned so that it extends approximately upwards whilst moving away from the latter.

Preferably, the length of the metallic framework along the said longitudinal direction is approximately the same as the length, along this same direction, of the block made of lead or of one of its alloys, cast over this framework and which embeds the latter. This configuration, in which the framework is hugged by the lead block over its entire length, advantageously means that the risk of compaction of the block along the longitudinal direction can be minimised along its entire length. Furthermore the framework which therefore extends from one end of the radiological protection structure to the other may therefore be stressed in compression to improve vertical load resistance. On this point it should be noted that the framework may be made in once piece or using portions attached firmly together, for example by welding. Furthermore, it should be recalled that a lead block of a protection structure could include several separate frameworks which, in the preferred case just described, each extend over the entire length of this block, and still be within the framework of the invention.

Preferably, said radiological protection device includes multiple radiological protection structures distributed around the cavity, for example between two concentric shells of the lateral body of the packaging, so as to fill the annular space formed between these.

It might then be envisaged that each radiological protection structure be housed in a metal profile which is open in a circumferential direction, enabling the radiological protection structure to be introduced into its corresponding profile by a relative movement along this same direction. These profiles are preferably made of aluminium or from one of its alloy for heat transfer reasons. It is therefore preferentially envisaged that each profile therefore exhibits two opposite sides, facing and in contact or in close proximity respectively to the two concentric shells, in order to facilitate heat transfer between them.

According to one alternative realisation, it is possible to make the said radiological protection device so that it is made up of a single radiological protection structure which forms a one-piece shell around the said cavity, preferably between the two above mentioned concentric shells. Thus, in this other configuration, the radiological protection device is no longer segmented into several structures each extending along a given angular sector and all positioned adjacent to each other along the tangential/circumferential direction, but take the form of a one-piece block of annular shape which surrounds the housing cavity.

In this case the radiological protection device may be cast directly between the two concentric shells, with one or more reinforcement frameworks being initially present in the inter-shell space.

Another subject of the invention is a method for the manufacture of a packaging for the transportation and/or storage of nuclear materials as described above, which includes a manufacturing step for the said radiological protection structure, carried out by casting lead or one of its alloys in a mould within which said metallic reinforcement framework has been placed beforehand.

Naturally, said radiological protection structure thus obtained may be machined before being housed in the space provided for this purpose on the lateral body of the packaging.

Finally, as stated above, it should be noted that in the specific case where the radiological protection device is such that it is made up of a single structure which forms a one-piece shell around the cavity, the lead may then be cast directly between two concentric shells of the lateral body which form the aforementioned mould, with one or more reinforcement frameworks being initially arranged in the inter-shell annular space.

Other advantages and characteristics of the invention will appear in the detailed non-restrictive description below.

### BRIEF DESCRIPTION OF THE DRAWINGS

This description will be made in relation to the appended drawings, in which:

FIG. 1 represents a schematic view of a container for the transportation and/or storage of nuclear fuel assemblies, which includes a packaging according to a preferred embodiment of the present invention, shown only in outline;

FIG. 2 shows a more detailed transverse section view of the packaging, taken along the line II-II of FIG. 1;

FIG. 3 shows a perspective view of one of the radiological protection structures with which the packaging shown in the previous figures is equipped;

FIG. 4 shows a transverse section view of the radiological protection structure shown in FIG. 3;

FIGS. 5 to 5b show similar views to those shown in FIG. 4, where the radiological protection structure occurs in the form of an alternative realisation;

FIG. 6 shows a similar view to that shown in FIG. 5, where the radiological protection structure occurs in the form of an alternative realisation;

FIG. 7 shows a similar view to that shown in FIG. 2, with radiological protection structures like those shown in FIG. 6;

FIGS. 8 to 8c show similar views to those shown in FIGS. 4 to 5b, where the radiological protection structure occurs in the form of other alternative realisations, with frameworks which adopt a zigzag configuration and;

FIG. 9 also shows a similar view to those shown in FIGS. 4 to 5b, where the radiological protection structure occurs in yet another alternative form of realisation.

### DETAILED DESCRIPTION OF PREFERRED EMBODIMENTS

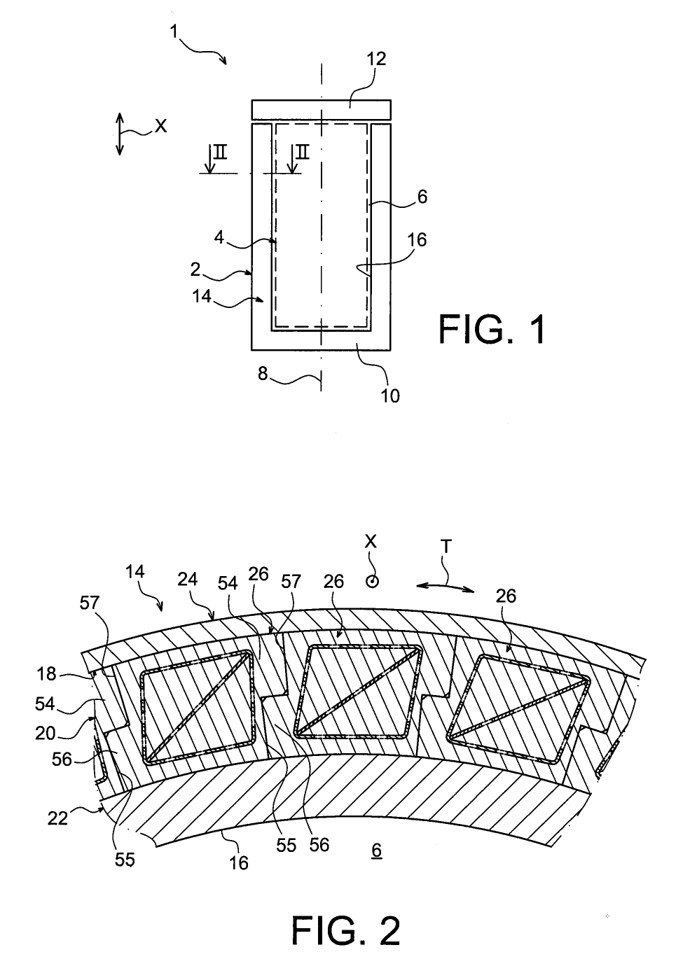

With reference first of all to FIG. 1, a container 1 for the transportation and/or storage of nuclear fuel assemblies can be seen. It should be recalled in this respect that the invention is in no way restricted to the transportation/storage of this type of nuclear material.

Overall the container 1 contains a packaging 2 which is the subject of the present invention, inside which are found a storage device 4, also referred to as a storage basket. It is envisaged that the device 4 be placed in a housing cavity 6 of the packaging 2, as shown schematically in FIG. 1, in which can also be seen the longitudinal axis 8 of this packaging, merging with the longitudinal axes of the storage device and of the housing cavity.

Throughout the description the term “longitudinal” should be understood as being parallel to the longitudinal axis 8 and to the longitudinal direction X of the packaging, and the term “transverse” should be understood as being orthogonal to this same longitudinal axis 8.

In a conventional manner, and as a reminder, it should be noted that the storage device 4 includes multiple adjacent housings arranged parallel to the axis 8, where each of these are suitable for holding at least one fuel assembly of square or rectangular section and preferably one only. The container 1 and this device 4 have been shown in a vertical position for loading/unloading of fuel assemblies, which differs from the horizontal/laid down position normally adopted during the transportation of the assemblies. In this respect, as will be shown in detail later, it is specified that the packaging according to the invention exhibits highly satisfactory behaviour in the event of a vertical free drop, during which this packaging moves along the longitudinal direction in its shown vertical position.

In general terms the packaging 2 essentially has a base 10 upon which the device 4 is designed to rest in a vertical position, a cover 12 and a lateral body 14 around which extends around and along the longitudinal axis 8, parallel to the direction X.

It is this lateral body 14 which defines the housing cavity 6, by means of an internal lateral surface 16, with an approximately cylindrical shape and circular cross-section, and whose axis merges with axis 8.

The base 10, which defines the base of the open cavity 6, or level of the cover 12, may be made in one piece with a part at least of the lateral body 14, and still be within the framework of the invention.

With reference now to FIG. 2, a part of the lateral body 14 can be seen in a detailed manner, and this exhibits first of all two metallic concentric shells which together form an annular space 18 centred on the longitudinal axis 18 of the packaging (not visible in this figure), where this space 18 is filled by a radiological protection device 20 which is specific to the present invention.

This protection device 20 is in particular designed to form a barrier against the gamma radiation emitted by the irradiated fuel assemblies housed in the cavity 6. It is therefore housed between the internal shell 22 whose internal surface corresponds to the internal lateral surface of the cavity 6, and the external shell 24.

As can be seen in FIG. 2, in this preferred embodiment of the present invention, the protective device 20 includes multiple radiological protection structures 26, preferably all approximately identical and positioned adjacent to each other along a tangential/circumferential direction T associated with the annular space 18. In other terms the radiological protection device 20, which extends right around the cavity 6 whilst filling the annular space 18, is segmented into several structures 26 which each extend along a given angular sector centred on the longitudinal axis of the packaging.

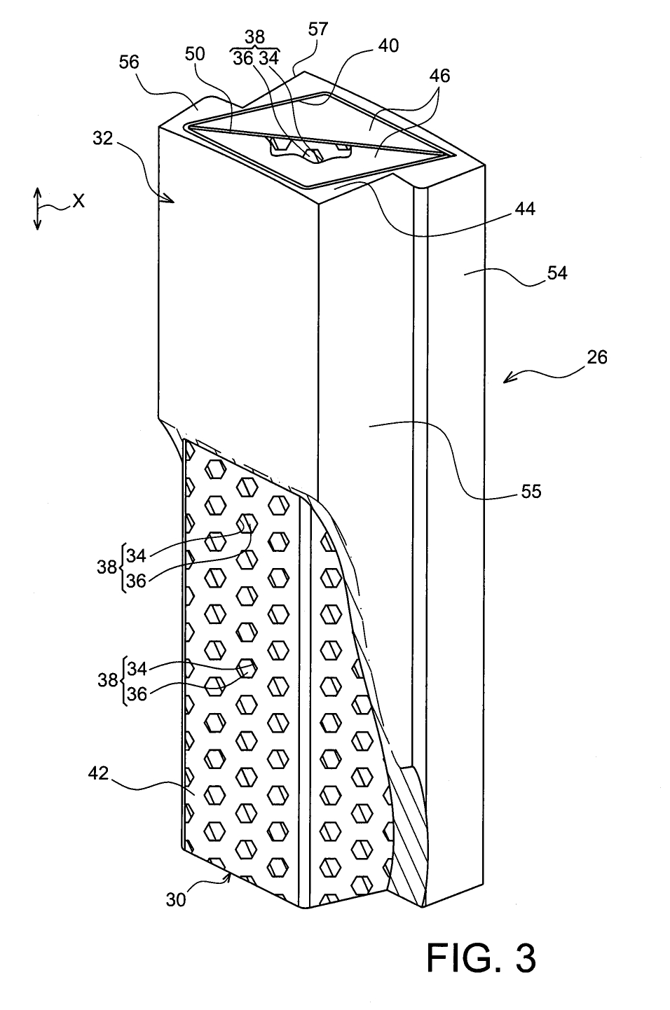

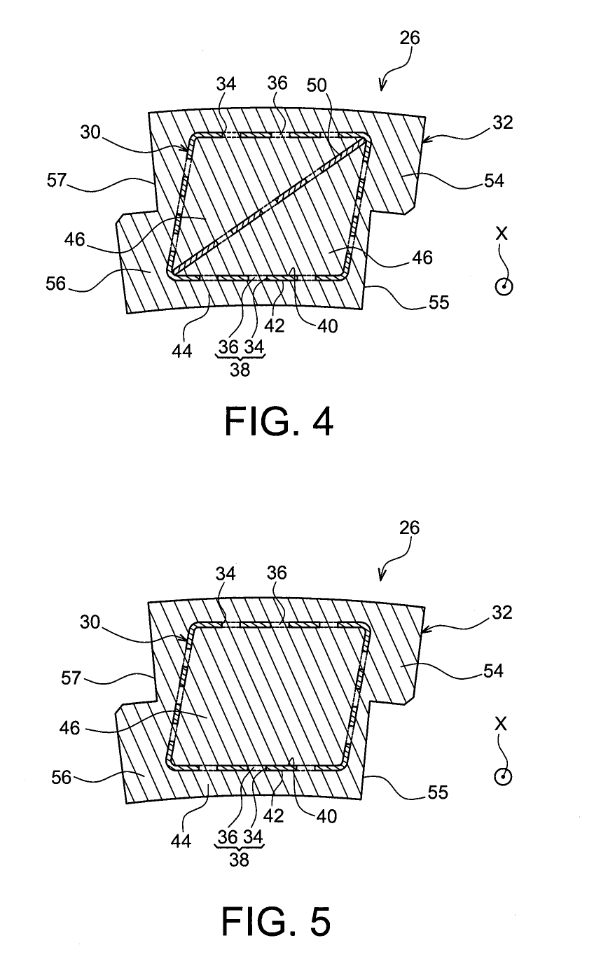

With reference to FIGS. 3 and 4, one of the radiological protection structures 26 can be seen, each of them extending preferably approximately over the entire length of the packaging, or at least all along the zone referred to as active defined by the fuel assemblies.

The structure 26 includes a metallic reinforcement framework 30 which extends along the longitudinal direction, preferably along the entire length of the structure 26. It is hugged by a block 32 made out of lead or of one of its alloys, cast over the framework 30 and embedding the latter, so that the framework 30 is completely covered laterally by the lead. Furthermore, in order to block relative movement along the longitudinal direction between the framework 30 and the block 32, and thus prevent compaction of the lead block along this same direction in the event of a vertical drop of the packaging, the framework 30 is equipped with multiple retention elements 34, provided so as to retain the cast block 34 in the longitudinal direction.

In the present case, the retention elements 34 are holes passing through the metallic framework, the latter being preferably made out of steel, for example out of black steel or stainless steel. After the lead is cast over the armature 30, each hole 34 has an element of lead 36 passing through it which forms an integral part of the cast block 32, where this element 36 takes the form of a slug which preferably fits against the entire lateral surface of the hole 34, which is for example of circular, hexagonal of other cross-section. The two elements 34, 36 which fit one into the other thus together form a mechanical link 38 between the block 32 and the framework 30, preventing relative movement of these two entities in relation to each other along the longitudinal direction. For a more effective end result, the holes 34 are preferably distributed over the framework 30, preferably in a homogeneous and regular manner and in particular along the longitudinal direction X in order to prevent compaction of the block 32 in the event of the packaging dropping vertically.

As an indication, it could be envisaged that the surface of the holes 34 corresponds to about 20 to 60% of the surface of the framework, and preferably 40% of the latter. It should be noted that this percentage is given assuming that the surface area of the framework is the surface area of the components of which it is formed, and not the sum of the two opposite surfaces of each of these elements.

This value interval results in the lead block 32 being properly supported in relation to the framework 30, due to the number and dimensions of the mechanical links 38 which it produces. Furthermore, this interval is suitable in that it offers rapid casting of the lead all around and inside the framework, given that the liquid lead in fact follows the holes 34 during casting so that it enters into any closed zones in the framework 30 before solidifying in these same holes 34.

To this end the metallic framework 30 takes the form, for example, of a hollow beam which defines an internal lateral wall 40 which delimits a void which extends along said longitudinal direction, and an external lateral wall 42, where each of these surfaces 40, 42 are hugged by the lead block 32, preferably along their entire length which also approximates to the length of the lead block 32.

In this preferred embodiment, the transverse section of the beam 30 takes the form of a parallelogram, so that the lead block 32, passing through each of the four sides of the parallelogram using the portions 36, exhibits an external crown 44 which fits against the external surface 42 of the beam over its entire circumference, and an internal portion 46 which fits against the interior surface 40 also over its entire circumference. In this preferred embodiment, the framework 30 also includes a central element 50 of the same length as the parallelogram, which, in transverse section, connects the two points which are furthest apart in this parallelogram. Consequently, the internal portion 46 of the block 32 takes the form of two sub-blocks of triangular cross-section which are firmly fixed to each other by means of the portions of lead 36 passing through the holes 34 made in the central element 50.

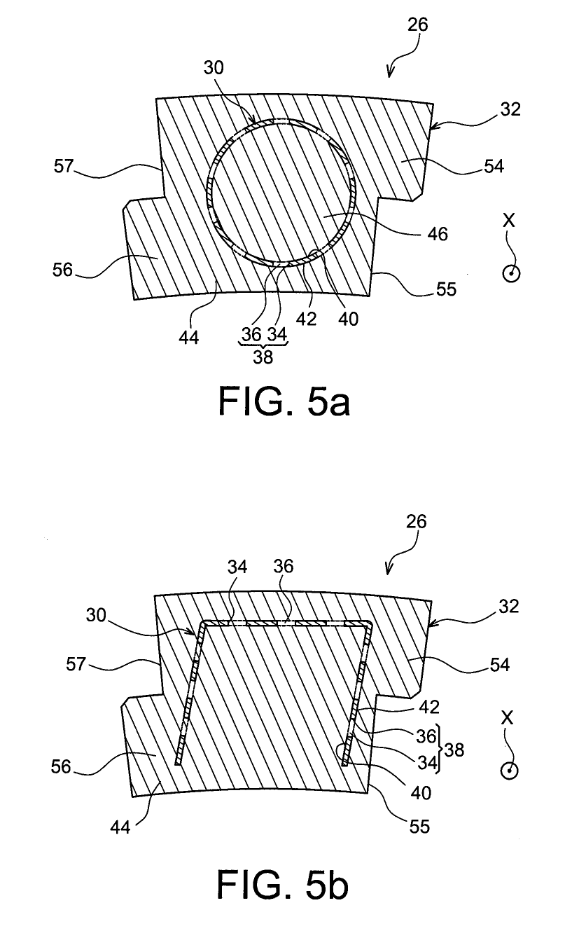

Naturally, this central element 50 which forms the diagonal is not mandatory, as shown by the alternative realisation shown in FIG. 5, in which the parallelogram alone forms the framework 30. Furthermore, any shape other than the parallelogram could be employed with an open or closed transverse section, and still be within the framework of the invention, and as shown in addition in FIGS. 5a and 5b which respectively represent a framework 30 of cross section approximately in the shape of a circle and a framework 30 of cross section approximately in the shape of a U, where each is embedded in a lead block 32.

In all cases it is therefore preferably arranged so that the metallic reinforcement framework 30 is completely or almost completely embedded in the cast block 32, in the sense that it is laterally covered by the lead over its entire circumference; that is, it is no longer visible from the exterior, laterally, over 360°. As an indication, it could be envisaged that only the end edges of the framework 30 are visible from the exterior of this, as seen at the upper end of the structure 26 represented in FIG. 3.

The block 32 is manufactured by casting lead or one of its alloys into a mould within which the metallic reinforcement framework 30 has been placed beforehand. It is therefore the shape of the mould which governs the external shape of the block 32. In this respect it includes, at its outer crown 44, a first radially external step 54 which extends tangentially. Thus on the relevant side of the block 32, one can successively see, moving radially from the exterior towards the interior, said tangential step 54, followed by an indentation 55.

In the same way, on the opposite side of the crown 44, a second radially internal step 56 is envisaged which extends tangentially. Thus on this opposite side of the block 32, one can successively see, moving radially from the interior towards the exterior, said tangential step 56 followed by an indentation 57.

Consequently, when the structures 26 are placed in the annular space 18, after these structures are removed from the mould, it is arranged so that the radially external step 54 of any structure 26 whatsoever becomes housed in the radially external indentation 57 of the structure directly adjacent in the tangential direction T, as shown in FIG. 2. In the same way, on the opposite side of any said structure 26 whatsoever, the radially internal step 56 of this structure becomes housed in the radially internal indentation 55 of the structure directly adjacent in the tangential direction T. It is therefore preferably arranged so that the tangential extent of overlaps between the steps 54, 56 which face each other two by two, and which are preferably in contact, are sufficiently large to satisfactorily limit the risk of gamma radiation leaks between the protective structures 26.

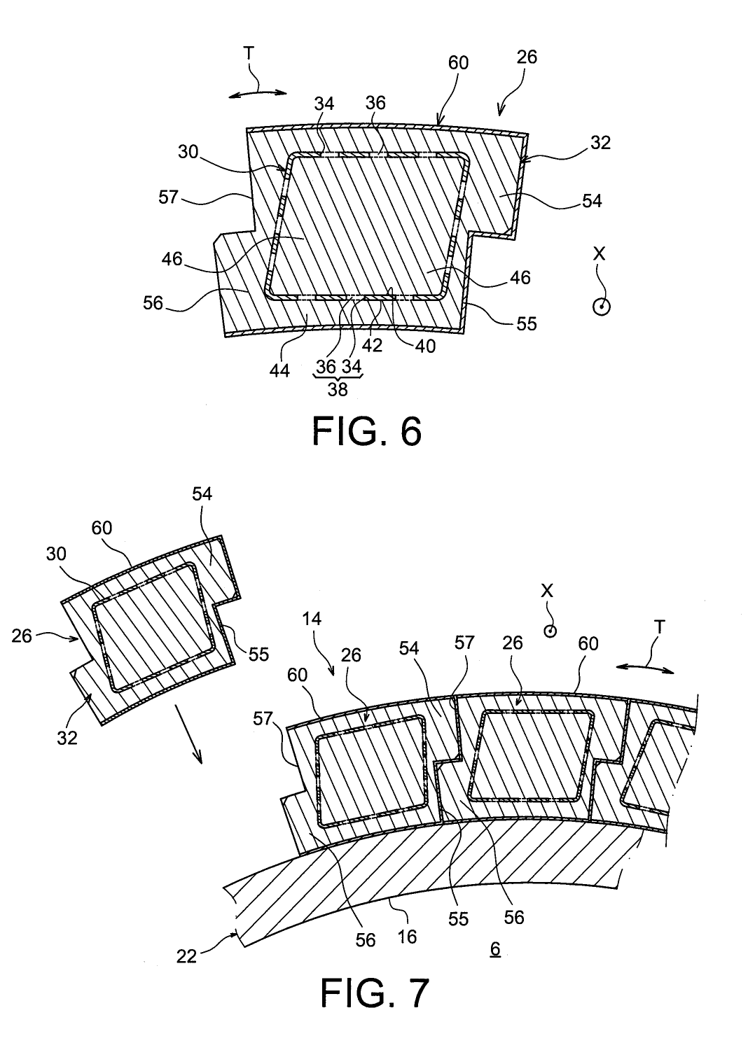

With reference to FIG. 6, another embodiment of the protective structure 26 can be seen which corresponds to that shown in FIG. 5, to which a heat transfer profile 60 has been added.

The profile 60 houses the block which embeds the framework 30, by presenting a shape which is open in the circumferential direction T, in transverse section. This opening allows the block 32 to be introduced into the profile 60 beforehand, by relative circumferential movement of the two elements. As can be seen in FIG. 6, the profile 60 has two opposite radially-spaced sides which run circumferentially, with these two sides being connected together at one end by a radial element formed so as to fit against the step 54 and the indentation 55 in the block 32 housed inside the profile. In addition the block fits against each of the two sides.

Thus, during the manufacture of the packaging, each block 32, preferably machined after the lead is cast over the framework, is introduced into a profile 60 through the circumferential opening provided for this purpose, by moving the block in the circumferential direction T until its step 54 and indentation 55 fit against the radial junction element of the profile 60. Each profile 60, equipped in this way with its protective structure 26, is then placed around the internal shell 22, with the radial element fitting against the step 56 and the indentation 57 of the block 32 housed in an adjacent profile 60, as shown in FIG. 7. In order to do this, an approximately radial movement of the profile 60 equipped with its protective structure 26 can be envisaged, as shown schematically by the arrow in this same figure.

This type of approach allows the internal shell 22 to be gradually covered whilst progressing along the circumferential direction T, and is repeated until this internal shell 22 is completely covered laterally by structures 26.

It should be noted that subsequently the external shell of the lateral body 14 is arranged around the structures 26 housed in the profiles 60, with, preferably, a previous step which involves the fastening firmly together of circumferentially adjacent profiles, for example by welding over their entire length, which preferably corresponds to approximately the length of the block 32 and of the framework 30. As an indication, longitudinal welding is preferably carried out between the radially external side of a profile 60 and the radial junction element belonging to the directly consecutive profile 60.

Once the external shell is in place, the two sides of the profile 60 are then facing and in contact with or in close proximity to the two concentric shells respectively, in order to facilitate heat transfer between them.

This specific feature, according to which the lead block is housed in an open profile, is naturally applicable irrespective of the shape adopted for the block and the metallic framework.

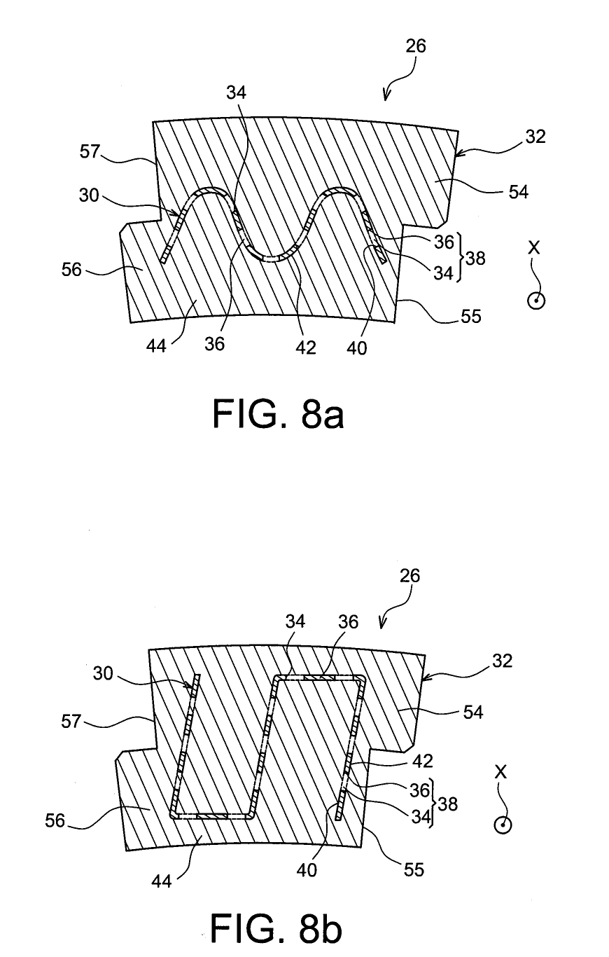

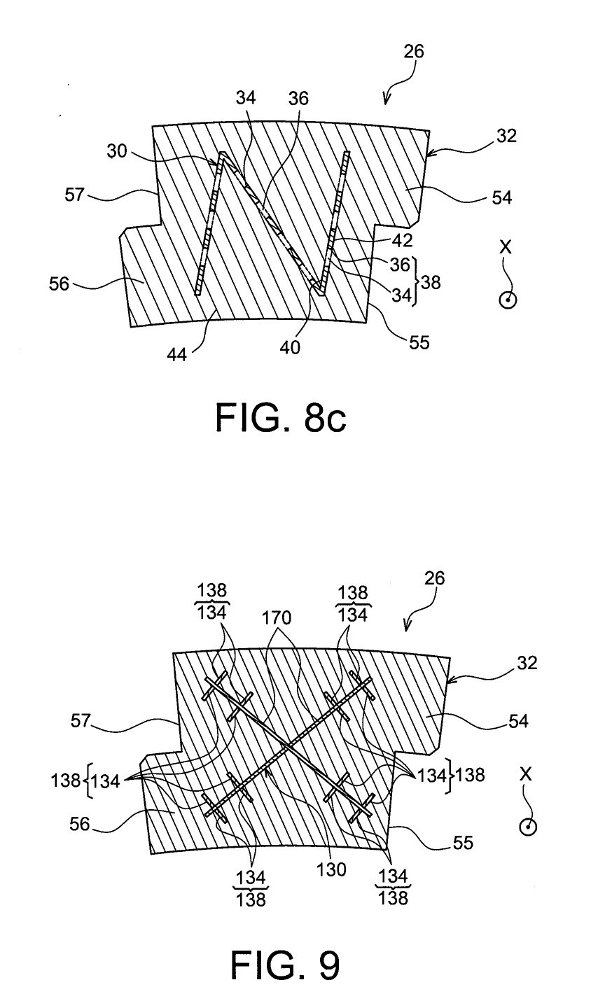

In FIGS. 8a to 8c other preferred embodiments can be seen, whose metallic reinforcement frameworks 30 each exhibit a transverse cross-section in the form of zigzags. The number and design of the zigzags may be selected according to the needs to be met. These may involve, for example, a repetition of a design in the form of waves, slots, or Vs, as respectively shown in FIG. 8a, 8b or 8c.

With reference to FIG. 9, an alternative realisation for the structure 26 is represented, where the differences from those described above rest once more in the shape of the metallic reinforcement framework 130. In effect, even though it could be done, it no longer has holes as retention elements for the cast lead block 32, but includes instead protrusions 134 made, for example, on the flat elements 170 of the metallic framework. More precisely, these flat elements 170, which extend from one end to the other of the structure 26 along a direction X, take the form, for example, of a cross in transverse section, with the protrusions 134 in the form of studs aligned transversely protruding on either side of each branch of the cross, as can be seen in FIG. 9. Thus a mechanical link 138 is made between each protrusion 134 and the adjacent portion of the lead block 32, in which this protrusion is embedded, where the purpose of the links 138 between the block 32 and the framework 130 is here still to block the relative movement of these two entities in relation to each other along the longitudinal direction

Naturally the form, number, and dimensions of the protrusions may be adapted according to the needs and constraints encountered, just as for the structure carrying these protrusions.

Naturally, various modifications can be made by those working in this field to the invention that has just been described as a non-restrictive example only. In particular each specific feature described for a given embodiment is applicable to all the other embodiments.

1. Packaging for the transportation and/or storage of nuclear materials, where said packaging includes a lateral body which extends along a longitudinal direction (X) of said packaging, with said lateral body forming a cavity for housing nuclear materials and being equipped with a radiological protection device,
characterised by the fact that said radiological protection device includes at least one radiological protection structure which includes at least one metallic reinforcement framework which extends along said longitudinal direction (X) and is hugged by a block made out of lead or of one of its alloys, cast over said metallic reinforcement framework, with the latter being equipped with at least one element for retaining the cast block along the longitudinal direction (X).
and by the fact that said metallic reinforcement framework is embedded in the cast block over at least part of its length along said longitudinal direction (X).

2. Packaging according to claim 1, characterised by the fact that said metallic reinforcement framework exhibits, in any transverse cross-section whatsoever, a shape which is not straight.

3. Packaging according to claim 2, characterised by the fact that said metallic reinforcement framework exhibits, in any transverse cross-section whatsoever, a zigzag shape.

4. Packaging according to claim 2, characterised by the fact that said metallic framework takes the form of a hollow structure which defines an internal lateral wall which delimits a void which extends along said longitudinal direction (X), and an external lateral wall.

5. Packaging according to claim 1, characterised by the fact that the said metallic framework is equipped with multiple elements for retaining the cast block along said longitudinal direction (X), distributed along this same direction.

6. Packaging according to claim 1, characterised by the fact that at least one element for retaining the cast block takes the form of a through hole made in the said metallic framework, through which said cast block passes.

7. Packaging according to claim 1, characterised by the fact that at least one element for retaining the cast block takes the form of a protrusion on the said metallic framework, and is embedded in said cast block.

8. Packaging according to claim 1, characterised by the fact that the length of the metallic framework, along said direction (X) is approximately the same as the length along this same direction of the block made out of lead or of one of its alloys, cast over this framework.

9. Packaging according to claim 1, characterised by the fact that said radiological protection device includes multiple radiological protection structures distributed circumferentially around the cavity.

10. Packaging according to claim 9, characterised by the fact that each radiological protection structure is housed in a metallic profile which is open in a circumferential direction (T), enabling the radiological protection structure to be introduced into its corresponding profile through a relative movement along this same direction (T).

11. Packaging according to claim 1, characterised by the fact that said radiological protection device is made up of a single radiological protection structure which forms a one-piece shell around said cavity.

12. Method for the manufacture of a packaging for the transportation and/or storage of nuclear materials according to claim 1, characterised by the fact that it includes a manufacturing step for said radiological protection structure, carried out by casting lead or one of its alloys into a mould within which said metallic reinforcement framework has been placed beforehand.
